(19) United States
(12) Patent Application Publication
(10) Pub. No.: US 2020/0081435 A1
(43) Pub. Date: Mar. 12, 2020

(54) AUTONOMOUS DRIVING ASSISTANCE METHOD, DRIVING DEVICE, ASSISTANCE DEVICE AND READABLE STORAGE MEDIUM

(71) Applicant: Baidu Online Network Technology (Beijing) Co., Ltd., Beijing (CN)

(72) Inventor: Youhan CHEN, Beijing (CN)

(73) Assignee: Baidu Online Network Technology (Beijing) Co., Ltd., Beijing (CN)

(21) Appl. No.: 16/514,131

(22) Filed: Jul. 17, 2019

(30) Foreign Application Priority Data
Sep. 6, 2018 (CN) 201811039166.9

(51) Int. Cl. G05D 1/00; G05D 1/02; G05B 13/02

(52) U.S. Cl. CPC G05D 1/0088; G05D 2201/0213; G05B 13/027; G05D 1/0221

(57) ABSTRACT

An autonomous driving assistance method, a driving device, an assistance device and a readable storage medium are provided by the present disclosure. The driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using the optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

### CROSS-REFERENCE TO RELATED APPLICATION

The present application claims priority to Chinese application number 201811039166.9, filed on Sep. 6, 2018, which is incorporated by reference in its entirety.

### TECHNICAL FIELD

The present disclosure relates to autonomous driving technology, and more particularly to an autonomous driving assistance method, a driving device, an assistance device and a readable storage medium.

### BACKGROUND

With the development of science and technology and the advancement of society, autonomous driving technology has become a developing trend in the field of transportation.

In the prior art, a driving device performs an autonomous driving task through a preset autonomous driving model. The driving device collects current scene information in real time, and uses the autonomous driving model to process the scene information, so as to output a corresponding driving instruction to the driving device.

However, since the autonomous driving model is preset in the driving device, once the driving device encounters complex terrain or a complex road condition, the problem would most likely to occur that the autonomous driving model processes the scene information, causing the driving device to fail to continue performing the autonomous driving task.

### SUMMARY

For the above-mentioned problem that when performing an autonomous driving task, an existing deriving device fails to continue performing the autonomous driving task since a preset autonomous driving model cannot process scene information, the present disclosure provides an autonomous driving assistance method, a driving device, an assistance device and a readable storage medium.

In one aspect, the present disclosure provides an autonomous driving assistance method, including:

processing collected current scene information by using a current autonomous driving model, and initiating an assistance driving request to an assistance device according to a processing result;

receiving and performing a driving instruction feedback by the assistance device, where the driving instruction is used to optimize the current autonomous driving model in conjunction with the current scene information, so as to perform a following autonomous driving task by using the optimized autonomous driving model.

In an alternative embodiment, the autonomous driving model includes a deep learning algorithm model;

the driving instruction is specifically used to generate a training sample in conjunction with the current scene information; training the deep learning algorithm model by using the training sample to obtain a trained deep learning algorithm model; where the trained deep learning algorithm model is the optimized autonomous driving model.

In an alternative embodiment, the processing collected current scene information by using a current autonomous driving model, and initiating an assistance driving request to an assistance device according to a processing result includes:

processing the collected current scene information by using the current autonomous driving model to obtain the processing result;

determining a confidence of the processing result;

initiating the assistance driving request to the assistance device, when the confidence is less than a preset threshold.

In an alternative embodiment, when the confidence is greater than or equal to the preset threshold, performing an autonomous driving task according to the processing result.

In another aspect, the present disclosure provides an autonomous driving assistance method including:

receiving an assistance driving request initiated by a driving device, where the driving device processes collected current scene information by using a current autonomous driving model, and initiates the assistance driving request according to a processing result;

receiving a driving instruction triggered by a user, and transmitting the driving instruction to the driving device, so that the driving instruction is performed by the driving device; where the driving instruction is used to optimize the current autonomous driving model in conjunction with the current scene information, so as to perform a following autonomous driving task by using the optimized autonomous driving model.

In an alternative embodiment, the driving request and the driving instruction are transmitted to the driving device through a wireless mobile network.

In an alternative embodiment, the driving request and the driving instruction are transmitted to the driving device through near field communication technology.

In still another aspect, the present disclosure provides a driving device including:

a first processing unit, configured to process collected current scene information by using a current autonomous driving model, and obtain a processing result;

a first communicating unit, configured to initiate an assistance driving request to an assistance device according to the processing result; and further configured to receive a driving instruction feedback by the assistance device, so that the driving instruction is performed by the driving device, wherein the driving instruction is used to optimize the current autonomous driving model in conjunction with the current scene information, so as to perform a following autonomous driving task by using the optimized autonomous driving model.

In an alternative embodiment, the autonomous driving model includes a deep learning algorithm model;

the driving instruction is specifically used to generate a training sample in conjunction with the current scene information; train the deep learning algorithm model by using the training sample to obtain a trained deep learning algorithm model; where the trained deep learning algorithm model is the optimized autonomous driving model.

The first processing unit is further configured to determine a confidence of the processing result; when the confidence is less than a preset threshold, the communicating unit initiates the assistance driving request to the assistance device.

When the confidence is greater than or equal to the preset threshold, the driving device performs an autonomous driving task according to the processing result.

In still another aspect, the present disclosure provides an assistance device including:

a second communicating unit, configured to receive an assistance driving request initiated by a driving device, where the driving device processes collected current scene information by using a current autonomous driving model, and initiates the assistance driving request according to a processing result;

an interacting unit, configured to receive a driving instruction triggered by a user;

the second communicating unit is further configured to transmit the driving instruction to the driving device, so that the driving instruction is performed by the driving device; where the driving instruction is used to optimize the current autonomous driving model in conjunction with the current scene information, so as to perform a following autonomous driving task by using the optimized autonomous driving model.

In an alternative embodiment, the driving instruction is transmitted by the second communicating unit to the driving device through a wireless mobile network.

In an alternative embodiment, the driving instruction is transmitted by the second communicating unit to the driving device through near field communication technology.

In still another aspect, the present disclosure provides a driving device including: a memory, a processor connected to the memory, and a computer program stored on the memory and executable on the processor, where,

when executing the computer program, the processor executes the method according to any one of the preceding aspects.

In a further aspect, the present disclosure provides an assistance device including: a memory, a processor connected to the memory, and a computer program stored on the memory and executable on the processor, where,

when executing the computer program, the processor executes the method according to any one of the preceding aspects.

In still another aspect, the present disclosure provides a readable storage medium, including a program that, when being executed on a terminal, causes the terminal to implement the method according to any of the preceding aspects.

In a final aspect, the present disclosure provides a readable storage medium, including a program that, when being executed on a terminal, causes the terminal to implement the method according to any of the preceding aspects.

An autonomous driving assistance method, a driving device, an assistance device and a readable storage medium are provided by the present disclosure. The driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using the optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

### BRIEF DESCRIPTION OF THE DRAWINGS

Through the above drawings, specific embodiments of the present disclosure have been shown, which will be described in more detail later. These drawings and the text are not intended to limit the scope of the present disclosure in any way, but to illustrate concepts of the present disclosure to those skilled in the art with reference to the specific embodiments.

FIG. 1 is a schematic diagram of a network architecture on which the present disclosure is based;

FIG. 2 is a schematic flowchart diagram of an autonomous driving assistance method according to Embodiment 1 of the present disclosure;

FIG. 3 is a schematic flowchart diagram of an autonomous driving assistance method according to Embodiment 2 of the present disclosure;

FIG. 4 is a schematic flowchart diagram of an autonomous driving assistance method according to Embodiment 3 of the present disclosure;

FIG. 5 is a schematic flowchart diagram of an autonomous driving assistance method according to Embodiment 4 of the present disclosure;

FIG. 6 is a schematic structural diagram of a driving device according to Embodiment 5 of the present disclosure;

FIG. 7 is a schematic structural diagram of an assistance device according to Embodiment 6 of the present disclosure;

FIG. 8 is a schematic diagram of a hardware structure of a driving device according to Embodiment 7 of the present disclosure; and

FIG. 9 is a schematic diagram of a hardware structure of an assistance device according to Embodiment 8 of the present disclosure.

The drawings mentioned herein are incorporated in and constitute a part of the specification, where embodiments consistent with the present disclosure are shown to explain principles of the present disclosure together with the specification.

### DETAILED DESCRIPTION OF THE EMBODIMENTS

In order to make the objectives, technical solutions, and advantages of the embodiments of the present disclosure more clearly, the technical solutions in the embodiments of the present disclosure are described clearly and comprehensively in the following with reference to the accompanying drawings of the embodiments of the present disclosure.

With the development of science and technology and the advancement of society, autonomous driving technology has become a developing trend in the field of transportation.

In the prior art, a driving device performs an autonomous driving task through a preset autonomous driving model. The driving device collects current scene information in real time, and uses the autonomous driving model to process the scene information, so as to output a corresponding driving instruction to the driving device.

However, since the autonomous driving model is preset in the driving device, once the driving device encounters complex terrain or a complex road condition, the problem would most likely to occur that the autonomous driving model processes the scene information, causing the driving device to fail to continue performing the autonomous driving task.

For the above-mentioned problem that when performing an autonomous driving task, an existing deriving device fails to continue performing the autonomous driving task since a preset autonomous driving model cannot process scene information, the present disclosure provides an autonomous driving assistance method, a driving device, an assistance device and a readable storage medium. It should be noted that the autonomous driving assistance method, the device and the readable storage medium provided by the present disclosure can be applied to application scenarios where autonomous driving is employed, and these application scenarios include, but are not limited to, a manned driverless scenario, a scenario that a non-manned unmanned machine automatically executes engineering tasks including path finding and the like.

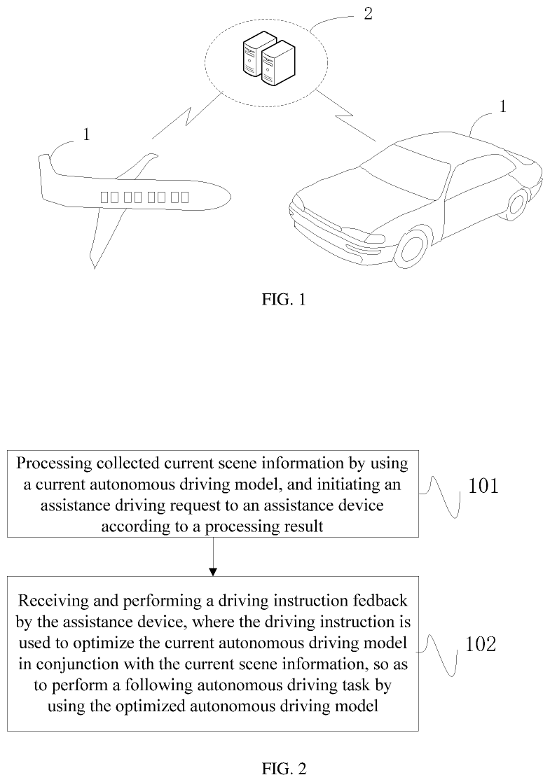

FIG. 1 is a schematic diagram of a network architecture on which the present disclosure is based. As shown in FIG. 1, the network architecture on which the present disclosure is based at least includes: a driving device 1 and an assistance device 2, where the driving device 1 refers to a device or a module in a motorized device such as an unmanned vehicle, an unmanned aerial vehicle, or an unmanned robot etc. The assistance device 2 refers to a human-machine interaction terminal that can have a communication connection with the driving device 1 and perform data interactions.

FIG. 2 is a schematic flowchart diagram of an autonomous driving assistance method according to Embodiment 1 of the present disclosure.

As shown in FIG. 2, the autonomous driving assistance method includes:

Step 101, processing collected current scene information by using a current autonomous driving model, and initiating an assistance driving request to an assistance device according to a processing result.

Step 102, receiving and performing a driving instruction feedback by the assistance device, wherein the driving instruction is used to optimize the current autonomous driving model in conjunction with the current scene information, so as to perform a following autonomous driving task by using the optimized autonomous driving model.

It should be noted that an execution body of the autonomous driving assistance method provided by the present disclosure may specifically be a driving device shown in FIG. 1. Specifically, the present disclosure provides an autonomous driving assistance method, first, during performing the autonomous driving task, the driving device needs to continuously receive current scene information collected by a collecting module on a motorized device, where the collecting module includes an image capturing device disposed on the motorized device, and may further include a sensor unit disposed within the motorized device for sensing or testing an operational status and operational parameters of the motorized device. After receiving the current scene information, the driving device inputs the current scene information into the current autonomous driving model, and the information is analyzed and processed by the autonomous driving model to output a processing result. The autonomous driving model may use an existing model architecture, optionally, the output processing result includes a matching degree for each driving instruction in the current scene, and an autonomous driving instruction that most matches the current scene.

The driving device may initiate the assistance driving request to the assistance device according to the processing result, so that the assistance device returns a corresponding driving instruction to the driving device, in a way of triggering the driving instruction by a user, after receiving the assisting driving request initiated by the driving device. The driving device may execute the driving instruction after receiving it.

Different from the prior art, in the present embodiment, in order to improve intelligence of the driving device to enable it to identify more complex terrain, in the case that a driving device needs to initiate an assisting driving request to the assistance device, it can optimize a current autonomous driving model by using the received driving instruction feedback by the assistance device and the current scene information collected by itself. That is, an optimized autonomous driving model, which is obtained by using the driving instructions feedback by the assistance device and the collected current scene information to optimize the current autonomous driving model, is capable of processing the aforementioned scene information. The optimized autonomous driving model can be used as an autonomous driving model for the driving device to perform a following autonomous driving task. It should be noted that the optimization process may be performed by the driving device provided by the present disclosure, or may be performed by a cloud server, and may also be performed by the assistance device, where this embodiment is exemplified by taking the driving device as the execution body.

By adopting such an autonomous driving assistance method that is optimized continuously, the autonomous driving model has the processing manner of keeping learning more complicated scene information, thereby improving its ability of processing and outputting regarding various complex terrains.

According to the autonomous driving assistance method provided by the present disclosure, a driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using an optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

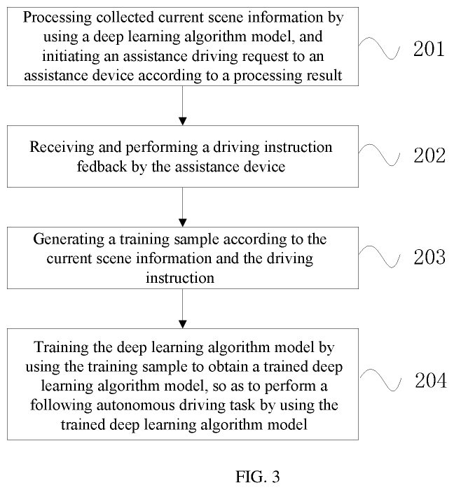

Based on Embodiment 1, FIG. 3 is a schematic flowchart diagram of an autonomous driving assistance method according to Embodiment 2 of the present disclosure. It should be noted that, the autonomous driving assistance method in Embodiment 2 is exemplified by taking a driving device as the execution body for optimizing a deep learning algorithm model. In other alternative implementations, it can also be an assistance device, a cloud server, and the like to optimize the deep learning algorithm model.

As shown in FIG. 3, the autonomous driving assistance method includes:

Step 201, processing collected current scene information by using a deep learning algorithm model, and initiating an assistance driving request to an assistance device according to a processing result.

Step 202, receiving and performing a driving instruction feedback by the assistance device.

Step 203, generating a training sample according to the current scene information and the driving instruction.

Step 204, training the deep learning algorithm model by using the training sample to obtain a trained deep learning algorithm model, so as to perform a following autonomous driving task by using the trained deep learning algorithm model.

Different from Embodiment 1, in Embodiment 2, the autonomous driving model includes a deep learning algorithm model, where the deep learning algorithm model specifically includes, but is not limited to, a neural belief network model, a convolutional neural network model, and a recursive neural network model. In Embodiment 2, first, during performing the autonomous driving task, the driving device needs to continuously receive current scene information collected by a collecting module on a motorized device, where the collecting module includes an image capturing device set on the motorized device, and may further include a sensor unit set within the motorized device for sensing or testing an operational status and operational parameters of the motorized device. After the driving device receives the current scene information, the driving device inputs the current scene information into the deep learning algorithm model, where the information is analyzed and processed by the deep learning algorithm model to output a processing result. The processing result output from the deep learning algorithm model includes a matching degree for each driving instruction in the current scene, and an autonomous driving instruction that most matches the current scene.

The driving device may initiate the assistance driving request to the assistance device according to the processing result, so that the assistance device returns a corresponding driving instruction to the driving device, in a way of triggering the driving instruction by a user, after receiving the assisting driving request initiated by the driving device. The driving device may execute the driving instruction after receiving it.

In the present embodiment, in the case that a driving device needs to initiate an assisting driving request to an assistance device, it can train a current deep learning algorithm model again by using a received driving instruction feedback by the assistance device and current scene information collected by itself. That is, after receiving the driving instruction, the driving device may generate a training sample for training the deep learning algorithm model by using the driving instruction and the current scene information. Subsequently, the deep learning algorithm model is trained by using the training sample to obtain a trained deep learning algorithm model, so as to perform a following autonomous driving task by using the trained deep learning algorithm model. By adopting the manner of keeping a deep learning algorithm model learning from a training sample, the deep learning algorithm model can be perfected, its ability of processing and outputting regarding various complex terrains can also be improved.

According to the autonomous driving assistance method provided by the present disclosure, a driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using an optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

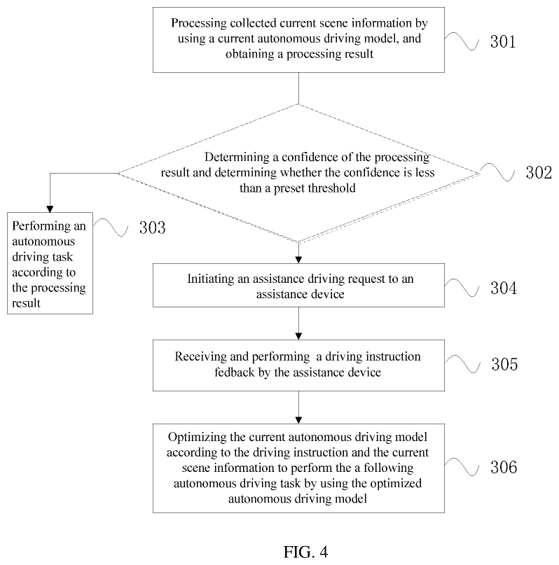

Based on Embodiment 1 or Embodiment 2, FIG. 4 is a schematic flowchart diagram of an autonomous driving assistance method according to Embodiment 3 of the present disclosure. It should be noted that, the autonomous driving assistance method in Embodiment 2 is exemplified by taking a driving device as the execution body for optimizing a deep learning algorithm model. In other alternative implementations, it can also be an assistance device, a cloud server, and the like to optimize the deep learning algorithm model.

As shown in FIG. 4, the autonomous driving assistance method includes:

Step 301, processing collected current scene information by using a current autonomous driving model, and obtaining a processing result.

Step 302, determining a confidence of the processing result and determining whether the confidence is less than a preset threshold.

If the confidence is less than the preset threshold, Step 304 is executed; otherwise, Step 303 is executed.

Step 303, performing an autonomous driving task according to the processing result.

Step 304, initiating an assistance driving request to an assistance device.

Step 305, receiving and performing a driving instruction feedback by the assistance device.

Step 306, optimizing the current autonomous driving model according to the driving instruction and the current scene information to perform a following autonomous driving task by using the optimized autonomous driving model.

Different from Embodiment 1, the third embodiment provides an autonomous driving assistance method, first, during performing the autonomous driving task, the driving device needs to continuously receive current scene information collected by a collecting module on a motorized device, where the collecting module includes an image capturing device set on the motorized device, and may further include a sensor unit set within the motorized device for sensing or testing an operational status and operational parameters of the motorized device. After the driving device receives the current scene information, the driving device inputs the current scene information into the current autonomous driving model, where the information is analyzed and processed by the autonomous driving model to output a processing result.

Next, the driving device determines the confidence of the processing result, when the confidence is greater than or equal to the preset threshold, the driving device directly processes the result to perform the autonomous driving task; otherwise, it initiates the assistance driving request to the assistance device. The preset threshold of the confidence may be, for example, 50%.

Similar to the previous embodiments, the driving device may initiate the assistance driving request to the assistance device according to the processing result, so that the assistance device returns a corresponding driving instruction to the driving device, in a way of triggering the driving instruction by a user, after receiving the assisting driving request initiated by the driving device. The driving device may execute the driving instruction after receiving it

In order to improve intelligence of the driving device to enable it to identify more complex terrain, in the case that a driving device needs to initiate an assisting driving request to an assistance device, it can optimize a current autonomous driving model by using a received driving instruction feedback by the assistance device and current scene information collected by itself. That is, an optimized autonomous driving model, which is obtained by optimizing the current autonomous driving model using the driving instructions feedback by the assistance device and the collected current scene, is capable of processing the aforementioned scene information. The optimized autonomous driving model can be used as an autonomous driving model for the driving device to perform a following autonomous driving task. By adopting such an autonomous driving assistance method that is optimized continuously, the autonomous driving model has the processing manner of keeping learning more complicated scene information, thereby improving its ability of processing and outputting regarding various complex terrains.

According to the autonomous driving assistance method provided by the present disclosure, a driving device processes collected current scene information by using a current autonomous driving model, and initiates an assistance driving request to an assistance device according to a processing result; receives and performs a driving instruction feedback by the assistance device; optimizes the current autonomous driving model according to the driving instruction and the current scene information to perform a following autonomous driving task by using an optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

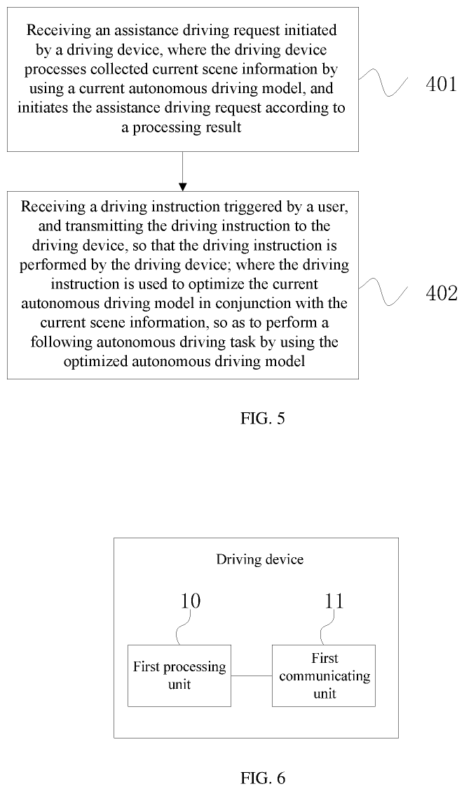

FIG. 5 is a schematic flowchart diagram of an autonomous driving assistance method according to Embodiment 4 of the present disclosure.

As shown in FIG. 5, the autonomous driving assistance method includes:

Step 401, receiving an assistance driving request initiated by a driving device, where the driving device processes collected current scene information by using a current autonomous driving model, and initiates the assistance driving request according to a processing result;

Step 402, receiving a driving instruction triggered by a user, and transmitting the driving instruction to the driving device, so that the driving instruction is performed by the driving device; where the driving instruction is used to optimize the current autonomous driving model in conjunction with the current scene information, so as to perform a following autonomous driving task by using the optimized autonomous driving model.

It should be noted that the execution body of the autonomous driving assistance method provided by the present disclosure may specifically be an assistance device shown in FIG. 1. Specifically, the assisting driving device can be an interactive terminal arranged at a remote end that can be communicated with the driving device remotely, or an interactive device arranged in a motorized device that can have near field communications with the driving device. During performing the autonomous driving task, the driving device continuously collects scene information and processes the current scene information by using the autonomous driving model, so as to perform the autonomous driving task. When a result output from the autonomous driving model triggers an assistance autonomous driving function, the driving device will initiate an assistance driving request to the assistance device. The assistance device can then interact with a user and transmit the driving instruction triggered by user to the driving device for execution, and the driving device optimizes the autonomous driving model deployed in it. A manner of interaction may include presenting current scene information to the user and accepting the driving instruction input by the user through a hardware device, where the hardware device includes, but are not limited to, a keyboard, a mouse, a touch screen, and the like. Optionally, the driving request and the driving instruction are transmitted to the driving device through a wireless mobile network. Optionally, the driving request and driving instruction are transmitted to the driving device through near field communication technology.

According to the autonomous driving assistance method provided by the present disclosure, a driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using an optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

FIG. 6 is a schematic structural diagram of a driving device according to Embodiment 5 of the present disclosure. As shown in FIG. 6, the driving device includes:

a first processing unit 10, configured to process collected current scene information by using a current autonomous driving model, and obtain a processing result;

a first communicating unit 11, configured to initiate an assistance driving request to an assistance device according to the processing result; and further configured to receive a driving instruction feedback by the assistance device, so that the driving instruction is performed by the driving device, where the driving instruction is used to optimize the current autonomous driving model in conjunction with the current scene information, so as to perform a following autonomous driving task by using the optimized autonomous driving model.

In an alternative embodiment, the autonomous driving model includes a deep learning algorithm model;

The driving instruction is specifically used to generate a training sample in conjunction with the current scene information; train the deep learning algorithm model by using the training sample to obtain a trained deep learning algorithm model; where the trained deep learning algorithm model is the optimized autonomous driving model.

The first processing unit 10 is further configured to determine a confidence of the processing result; when the confidence is less than a preset threshold, the communicating unit initiates the assistance driving request to the assistance device.

When the confidence is greater than or equal to the preset threshold, the driving device performs an autonomous driving task according to the processing result.

A person skilled in the art can clearly understand that for the sake of convenience and brevity of the description, specific working processes of the system described above and corresponding beneficial effects can be referred to the corresponding processes in the foregoing method embodiments, which are not described herein again.

According to the driving device provided by the present disclosure, a driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using the optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

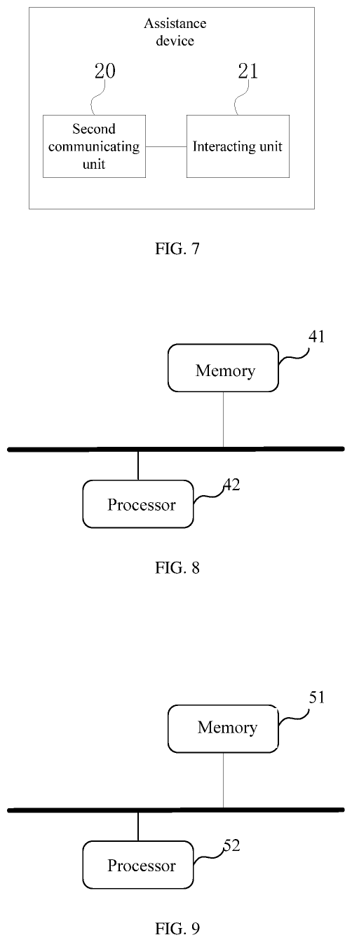

FIG. 7 is a schematic structural diagram of an assistance device according to Embodiment 6 of the present disclosure. As shown in FIG. 7, the assistance device includes:

a second communicating unit 20, configured to receive an assistance driving request initiated by a driving device, where the driving device processes collected current scene information by using a current autonomous driving model, and initiates the assistance driving request according to a processing result;

an interacting unit 21, configured to receive a driving instruction triggered by a user; and

the second communicating unit 20 is further configured to transmit the driving instruction to the driving device, so that the driving instruction is performed by the driving device; where the driving instruction is used to optimize the current autonomous driving model in conjunction with the current scene information, so as to perform a following autonomous driving task by using the optimized autonomous driving model.

The driving instruction is transmitted by the second communicating unit 20 to the driving device through a wireless mobile network.

The driving instruction is transmitted by the second communicating unit 20 to the driving device through near field communication technology.

A person skilled in the art can clearly understand that for the sake of convenience and brevity of the description, specific working processes of the system described above and corresponding beneficial effects can be referred to the corresponding processes in the foregoing method embodiments, which are not described herein again.

According to the driving device provided by the present disclosure, a driving device processes collected current scene information by using a current autonomous driving model, and initiates an assistance driving request to an assistance device according to a processing result; receives and performs a driving instruction feedback by the assistance device, where the driving instruction is used to optimize the current autonomous driving model in conjunction with the current scene information, so as to perform a following autonomous driving task by using an optimized autonomous driving model. Therefore, a problem, that when performing an autonomous driving task, an existing deriving device fails to continue performing the autonomous driving task since a preset autonomous driving model cannot process scene information, can be solved, improving intelligence and applicability of the autonomous driving model.

FIG. 8 is a schematic diagram of a hardware structure of a driving device according to Embodiment 7 of the present disclosure. As shown in FIG. 8, the driving device includes a processor 42 and a computer program stored on the memory 41 and executable on the processor 42, where when executing the computer program, the processor 42 executes the methods according to Embodiments 1-3 mentioned above.

FIG. 9 is a schematic diagram of a hardware structure of an assistance device according to Embodiment 8 of the present disclosure. As shown in FIG. 9, the assistance device includes a processor 52 and a computer program stored on the memory 51 and executable on the processor 52, where when executing the computer program, the processor 52 executes the method according to Embodiment 4 mentioned above.

The present disclosure provides a readable storage medium including a program that, when being executed on a terminal, causes the terminal to implement the methods according to Embodiments 1-3 mentioned above.

The present disclosure provides a readable storage medium including a program that, when being executed on a terminal, causes the terminal to implement the method according to Embodiment 4 mentioned above.

It will be understood by those skilled in the art that all or part of steps of the foregoing method embodiments may be implemented by a hardware related to program instructions. The aforementioned program can be stored in a computer readable storage medium. When the program is executed, a step including the above mentioned method embodiments is implemented; and the foregoing storage medium includes various media that can store program codes, such as a ROM, a RAM, a magnetic disk, or an optical disk.

At last, it should be noted that the above embodiments are only used to illustrate the technical solutions of the present disclosure, but are not limited thereto; although the present disclosure has been described in detail with reference to the foregoing embodiments, it will be understood by those of ordinary skill in the art that the technical solutions described in the foregoing embodiments may be modified or equivalently substituted for some or all of the technical features; while the modifications and substitutions will not make the nature of corresponding technical solution depart from the scope of the technical solution in respective embodiments of the present disclosure.

What is claimed is:

1. An autonomous driving assistance method, comprising:
processing collected current scene information by using a current autonomous driving model, and initiating an assistance driving request to an assistance device according to a processing result;
receiving and performing a driving instruction feedback by the assistance device, wherein the driving instruction is used to optimize the current autonomous driving model in conjunction with the current scene information, so as to perform a following autonomous driving task by using the optimized autonomous driving model.

2. The autonomous driving assistance method according to claim 1, wherein the autonomous driving model comprises a deep learning algorithm model;
the driving instruction is specifically used to generate a training sample in conjunction with the current scene information; training the deep learning algorithm model by using the training sample to obtain a trained deep learning algorithm model; wherein the trained deep learning algorithm model is the optimized autonomous driving model.

3. The autonomous driving assistance method according to claim 1, wherein the processing collected current scene information by using a current autonomous driving model, and initiating an assistance driving request to an assistance device according to a processing result comprises:
processing the collected current scene information by using the current autonomous driving model to obtain the processing result;
determining a confidence of the processing result;
initiating the assistance driving request to the assistance device, when the confidence is less than a preset threshold.

4. The autonomous driving assistance method according to claim 3, further comprising: when the confidence is greater than or equal to the preset threshold, performing an autonomous driving task according to the processing result.

5. An autonomous driving assistance method, comprising:
receiving an assistance driving request initiated by a driving device, wherein the driving device processes collected current scene information by using a current autonomous driving model, and initiates the assistance driving request according to a processing result;
receiving a driving instruction triggered by a user, and transmitting the driving instruction to the driving device, so that the driving instruction is performed by the driving device; wherein the driving instruction is used to optimize the current autonomous driving model in conjunction with the current scene information, so as to perform a following autonomous driving task by using the optimized autonomous driving model.

6. The autonomous driving assistance method according to claim 5, wherein the driving request and the driving instruction are transmitted to the driving device through a wireless mobile network.

7. The autonomous driving assistance method according to claim 5, wherein the driving request and the driving instruction are transmitted to the driving device through near field communication technology.

8. A driving device, comprising: a processor, and a computer readable medium for storing program codes, which, when executed by the processor, cause the processor to:
process collected current scene information by using a current autonomous driving model, and obtain a processing result;
initiate an assistance driving request to an assistance device according to the processing result; and further receive a driving instruction feedback by the assistance device, so that the driving instruction is performed by the driving device, wherein the driving instruction is used to optimize the current autonomous driving model in conjunction with the current scene information, so as to perform a following autonomous driving task by using the optimized autonomous driving model.

9. The driving device according to claim 8, wherein the autonomous driving model comprises a deep learning algorithm model; and
the driving instruction is specifically used to generate a training sample in conjunction with the current scene information; train the deep learning algorithm model by using the training sample to obtain a trained deep learning algorithm model; wherein the trained deep learning algorithm model is the optimized autonomous driving model.

10. The driving device according to claim 8, wherein, when the program codes cause the processor to process collected current scene information by using a current autonomous driving model, and obtain a processing result, the program codes further cause the processor to: determine a confidence of the processing result; when the confidence is less than a preset threshold, the program codes cause the processor to initiate the assistance driving request to the assistance device.

11. The driving device according to claim 10, wherein when the confidence is greater than or equal to the preset threshold, the driving device performs an autonomous driving task according to the processing result.

12. An assistance device, comprising a memory, a processor connected to the memory, and a computer program stored on the memory and executable on the processor, wherein:
when executing the computer program, the processor executes the method according to claim 5.

13. A readable storage medium, comprising a program that, when being executed on a terminal, causes the terminal to implement the method according to claim 1.

14. A readable storage medium, comprising a program that, when being executed on a terminal, causes the terminal to implement the method according to claim 5.
